(19) United States
(12) Patent Application Publication
(10) Pub. No.: US 2009/0009273 A1
(43) Pub. Date: Jan. 8, 2009

(54) Hall Effect Switching Circuit and Controlling Method for same

(76) Inventor: Ming-Hua KU, Hsinchu City (TW)

Correspondence Address: HDSL, P.O. BOX 220746, CHANTILLY, VA, 20153-0746, US

(21) Appl. No.: 12/146,815

(22) Filed: Jun. 26, 2008

(30) Foreign Application Priority Data
Jul. 2, 2007 (TW) 096123937

(51) Int. Cl. H01H 51/22

(52) U.S. Cl. 335/78

(57) ABSTRACT

A Hall effect switching circuit includes a magnetic south pole detecting unit configured for detecting and judging a magnetic field intensity of a magnetic south pole to produce a first triggering signal; a magnetic north pole detecting unit configured for detecting and judging a magnetic field intensity of a magnetic north pole to produce a second triggering signal; and a detecting and controlling unit connected to the magnetic south pole detecting unit and the magnetic north pole detecting unit. The detecting and controlling unit is configured for judging a polarity of a magnetic field according to the first triggering signal and the second triggering signal, and selecting a triggering signal corresponding to the polarity of the magnetic field as a switching signal of the Hall effect switching circuit in a predetermined detect and setup time after starting the Hall effect switching circuit.

### BACKGROUND

1. Field of the Invention

The present invention relates to a Hall effect switching circuit, and more particularly to a Hall effect switching circuit adapted into magnetic fields with two polarities simultaneously, and a controlling method for the same.

2. Description of the Related Art

Recently, Hall effect switching circuits mainly including a Hall device are widely used to displacement measurements or rotation measurements, etc. For example, the Hall effect switching circuits may be used in an upper cover (or a lower cover) of a foldable mobile phone to measure the distance between the upper cover and the lower cover, and the measuring result is a base for controlling a power supply thereof.

Referring to FIG. 1, a typical Hall effect switching circuit is provided. The Hall effect switching circuit 10 includes a Hall device 100, an amplifier 110, a comparator 120 and a controlling unit 130. The Hall effect switching circuit 10 operates by employing the Hall device 100 to determine a potential difference between two terminals thereof according to magnetic flux passed therethrough firstly. The potential difference between the two terminals of the Hall device 100 is amplified by the amplifier 110, and then the amplified potential difference is compared with a predetermined value by the comparator 120. The compared result is transmitted to the controlling unit 130 to be a switching signal for controlling on/off state of a switch.

However, the typical Hall effect switching circuit is only used in a magnetic filed with a changeless polarity. The relation between the output of the Hall effect switching circuit and the magnetic filed intensity only can be one of relations as shown in FIG. 2(a) and FIG. 2(b). Therefore, systems employing the typical Hall effect switching circuit must be used in the magnetic field with the special polarity, otherwise the systems cannot operate normally.

To solve the above problems, another typical Hall effect switching circuit as shown in FIG. 3 is provided. The Hall effect switching circuit 20 includes a Hall device 200, an amplifier 210, a first comparator 220, a second comparator 230 and a controlling unit 240. The Hall effect switching circuit 20 operates by employing the Hall device 200 to determine a potential difference between two terminals thereof according to magnetic flux passed therethrough. The polarity of the potential difference (positive or negative) corresponds to the polarity of the magnetic field, and the value of the potential difference corresponds to the magnetic filed intensity. The potential difference between the two terminals of the Hall device 200 is amplified by the amplifier 210, and then is compared by the first comparator 220 and the second comparator 230. The compared result is transmitted to the controlling unit 240 to produce a switching signal for controlling on/off state of a switch.

Referring to FIG. 4, a diagram for a relation between the output of the Hall effect switching circuit 20 and the magnetic field intensity is provided. The Hall effect switching circuit 20 includes two comparators, which can produce different responds according to the change of the magnetic field intensity with two different polarities, thus the oriented direction of the magnetic object is not limited when arranging the magnetic object.

However, after arranging the magnetic object, the direction for the polarity detected by the Hall effect switching circuit is determined, and there should no other detecting signals or outputs with opposite polarity. If appearing noise with the opposite polarity, the Hall effect switching circuit will operate according to the noise with the opposite polarity, such that misoperation phenomenon will be introduced.

What is needed, is providing a Hall effect switching circuit, which can solve the above problems.

### BRIEF SUMMARY

A Hall effect switching circuit in accordance with an exemplary embodiment of the present invention, is provided. The Hall effect switching circuit includes a magnetic south pole detecting unit configured for detecting and judging a magnetic field intensity of a magnetic south pole to produce a first triggering signal; a magnetic north pole detecting unit configured for detecting and judging a magnetic field intensity of a magnetic north pole to produce a second triggering signal; and a detecting and controlling unit connected to the magnetic south pole detecting unit and the magnetic north pole detecting unit. The detecting and controlling unit is configured for judging a polarity of a magnetic field according to the first triggering signal and the second triggering signal, and selecting a triggering signal corresponding to the polarity of the magnetic field as a switching signal of the Hall effect switching circuit in a predetermined detect and setup time after starting the Hall effect switching circuit.

A Hall effect switching circuit in accordance with another exemplary embodiment of the present invention, is provided. The Hall effect switching circuit includes a Hall device configured for sensing an intensity of a magnetic field to produce a sensing voltage; a magnetic south pole detecting unit configured for judging a magnetic field intensity of a magnetic south pole according to the sensing voltage to produce a first triggering signal; a magnetic north pole detecting unit configured for judging a magnetic field intensity of a magnetic north pole according to the sensing voltage to produce a second triggering signal; and a detecting and controlling unit connected to the magnetic south pole detecting unit and magnetic north pole detecting unit. The detecting and controlling unit is configured for judging a polarity of the magnetic according to the first triggering signal and the second triggering signal to select one triggering signal corresponding to the polarity of the magnetic field as a switching signal of the Hall effect switching circuit in a predetermined detect and setup time after starting the Hall effect switching circuit.

A Hall effect switching circuit in accordance with other exemplary embodiment of the present invention, is provided. The Hall effect switching circuit includes a Hall device configured for sensing an intensity of a magnetic field to produce a sensing voltage; a first comparator connected to the Hall device and configured for judging a magnetic field intensity of a magnetic south pole according to the sensing voltage to produce a first triggering signal; a second comparator connected to the Hall device and configured for a magnetic field intensity of a magnetic north pole according to the sensing voltage to produce a second triggering signal; and a detecting and controlling unit connected to the first comparator and the second comparator. The detecting and controlling unit is configured for judging a polarity of the magnetic according to the first triggering signal and the second triggering signal to select one triggering signal corresponding to the polarity of the magnetic field as a switching signal of the Hall effect switching circuit in a predetermined detect and setup time after starting the Hall effect switching circuit.

A controlling method for a Hall effect switching circuit in accordance with other exemplary embodiment of the present invention, is provided. The controlling method includes judging a magnetic field intensity of a magnetic south pole to produce a first triggering signal; judging a magnetic field intensity of a magnetic north pole to produce a second triggering signal; judging a polarity of a magnetic field according to the first triggering signal and the second triggering signal in a predetermined detect and setup time; and selecting one triggering signal corresponding to the polarity of the magnetic field as a switching signal of the Hall effect switching circuit.

A controlling method for a Hall effect switching circuit in accordance with other exemplary embodiment of the present invention, is provided. The controlling method includes sensing an intensity of a magnetic field to produce a sensing voltage; amplifying the sensing voltage; judging a magnetic field intensity of a magnetic south pole according to the amplified sensing voltage to produce a first triggering signal; judging a magnetic field intensity of a magnetic north pole according to the amplified sensing voltage to produce a second triggering signal; judging a polarity of the magnetic field according to the first triggering signal and the second triggering signal; and selecting one triggering signal corresponding to the polarity of the magnetic field as a switching signal of the Hall effect switching circuit.

Compared with the conventional art, the above Hall effect switching circuits and the controlling methods can sense the magnetic field intensity of the magnetic south pole and the magnetic north pole respectively, thus an oriented direction of the magnetic object is not limited. Furthermore, in their operation, only one polarity of the magnetic field intensity is sensed, thus the misoperation phenomenon introduced by noise may be avoided.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, circuit block diagram of a conventional LCD panel;

FIG. 2 is a schematic, circuit block diagram of a driving circuit, in accordance with an exemplary embodiment of the present invention;

FIG. 3 is a schematic, circuit block diagram of a driving controller, in accordance with an exemplary embodiment of the present invention;

FIG. 4 is a schematic, circuit diagram of a resistance adjustment unit, in accordance with an exemplary embodiment of the present invention;

FIG. 5 is a schematic, circuit block diagram of a driving circuit, in accordance with another exemplary embodiment of the present invention;

FIG. 6 is a schematic, circuit diagram of a circuit for adjusting analog power potentials, in accordance with another exemplary embodiment of the present invention; and

FIG. 7 is a schematic, circuit diagram of a circuit for adjusting ground potentials, in accordance with another exemplary embodiment of the present invention.

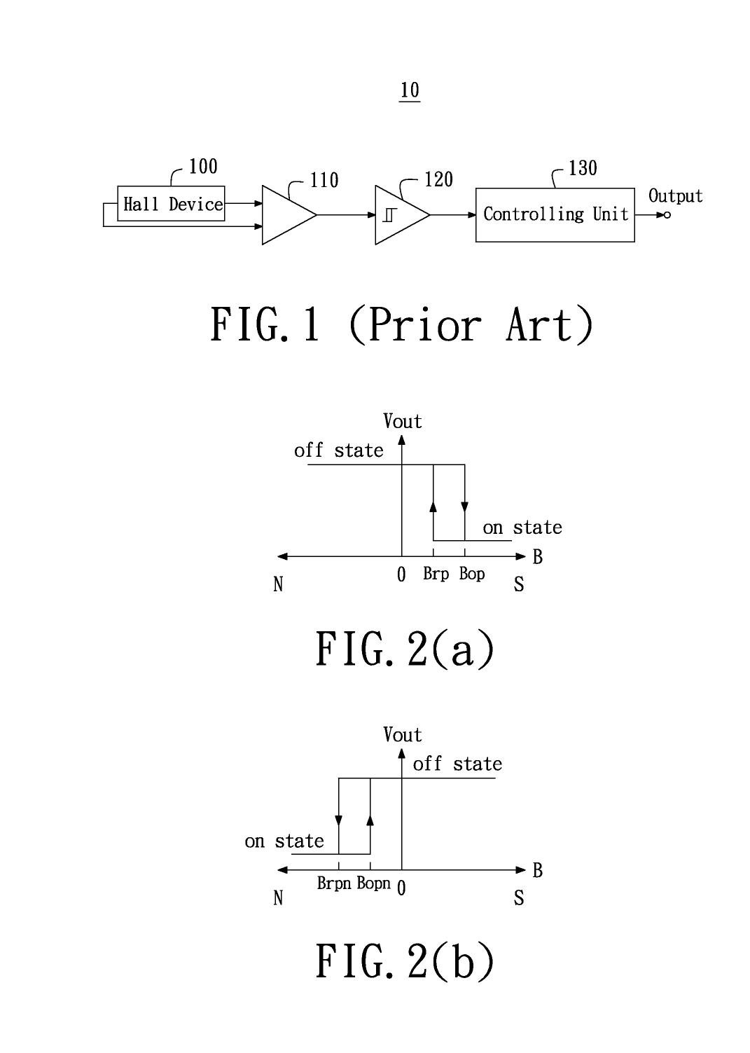

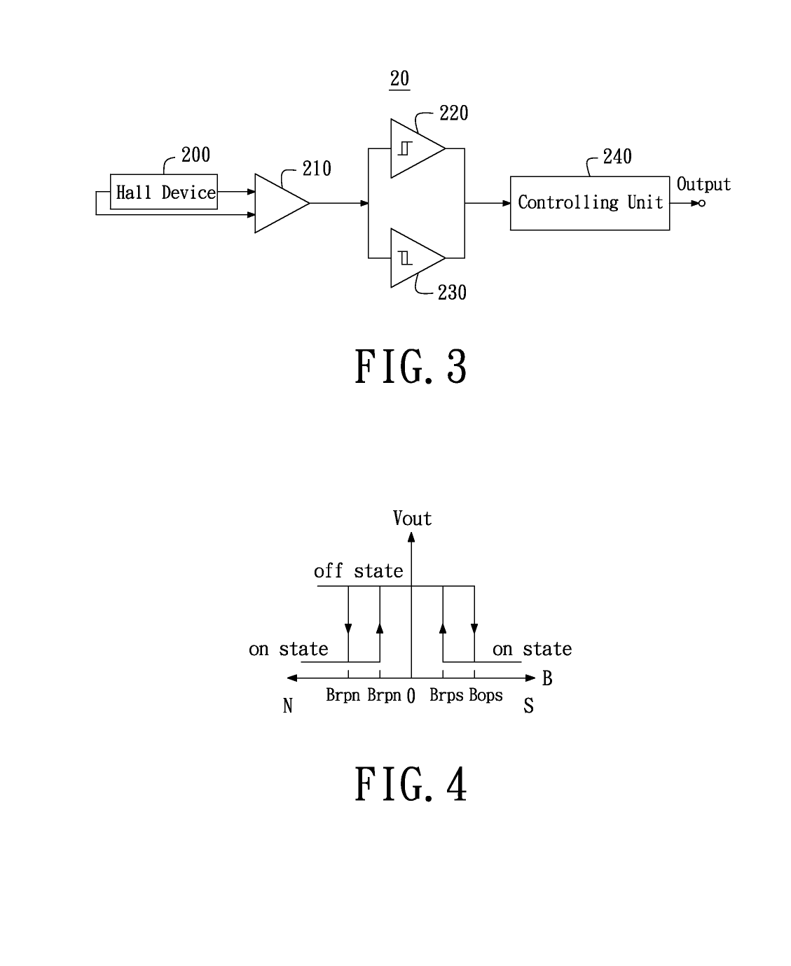

### DETAILED DESCRIPTION

Reference will now be made to the drawings to describe exemplary embodiments of the present Hall effect switching circuit, in detail. The following description is given by way of example, and not limitation.

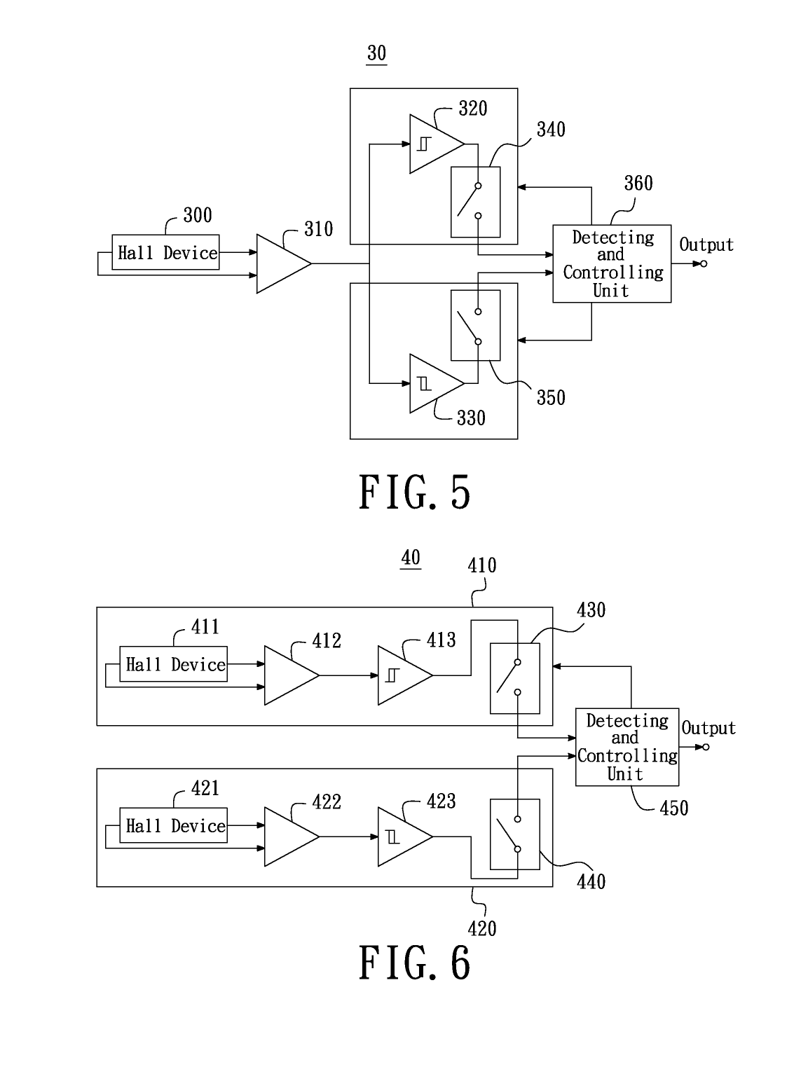

Referring to FIG. 5, a Hall effect switching circuit in accordance with a first exemplary embodiment of the present invention is provided. The Hall effect switching circuit 30 includes a Hall device 300, an amplifier 310, a first comparator 320, a second comparator 330, switching units 340, 350 and a detecting and controlling unit 360. The Hall device 300 is configured for determining a potential difference between two terminals thereof according to magnetic flux passed therethrough. A polarity of the potential difference (positive and negative) corresponds to a polarity of a magnetic field, and a value of the potential difference corresponds to a magnetic field intensity. Two input terminals of the amplifier 310 are connected to the two terminals of the Hall device 300 respectively to amplify the potential difference therebetween. An output terminal of the amplifier 310 is connected to an input terminal of the first comparator 320 and an input terminal of the second comparator 330 respectively. The first comparator 320 and the second comparator 330 are configured for judging the value of the amplified potential difference to judge the magnetic field intensity of a detected magnetic object. The first comparator 320 is configured for judging the magnetic field intensity of a magnetic south pole, and the second comparator is configured for judging the magnetic field intensity of a magnetic north pole. The switching unit 340 is arranged between the first comparator 320 and the detecting and controlling unit 360, and the switching unit 350 is arranged between the second comparator 330 and the detecting and controlling unit 360. The detecting and controlling unit 360 is configured for controlling on/off states of the switching units 340 and 350 to selectably use an output signal sent out from the first comparator 320 or the second comparator 330. The detecting and controlling unit 360 is also configured for controlling on/off operations of the first comparator 320 and the second comparator 330 to prevent from producing a corresponding output signal.

It should be noted that, the switching units 340 and 350 are not essential elements of the present invention. It should be obvious for persons skilled in the art, the switching units 340 and 350 may be omitted if the detecting and controlling unit 360 is configured for controlling on/off operations of the first comparator 320 and the second comparator 330.

The detecting and controlling unit 360 includes a detect and setup time defined therein. When resetting a power supply, the Hall effect switching circuit 30 starts. In the detect and setup time, the detecting and controlling unit 360 can judge the polarity of the magnetic field according to the output signals sent out from the first comparator 320 and the second comparator 330. If the polarity of the magnetic filed is the magnetic south pole, the switching unit 350 connected to the second comparator 330 will be turned off to select the output signal sent out from the first comparator 320 as a switching signal in the detect and setup time. Therefore, an output signal sent out from the Hall effect switching circuit 30 is only related to the magnetic field intensity of the magnetic south pole, and a relation between the output signal thereof and the magnetic field intensity is shown in FIG. 2(a). If the polarity of the magnetic field is the magnetic north pole, the switching unit 340 connected to the first comparator 320 will be turned off to select the output signal sent out from the second comparator 330 as the switching signal in the detect and setup time. Thus the output signal sent out from the Hall effect switching circuit 30 is only related to the magnetic field intensity of the magnetic north pole, and the relation between the output signal thereof and the magnetic field intensity is shown in FIG. 2(b).

Compared with the conventional art, the Hall effect switching circuit 30 includes the two comparators to judge the magnetic field intensity of the magnetic south pole and the magnetic north pole respectively, thus an oriented direction of the magnetic object is not limited. Furthermore, the detecting and controlling unit 360 is configured for judging the polarity of the magnetic field in the detect and setup time to select one comparator for judging the magnetic field intensity thereof, thus the misoperation phenomenon introduced by noise may be avoided.

Referring to FIG. 6, a Hall effect switching circuit in accordance with a second exemplary embodiment of the present invention is provided. In this exemplary embodiment, the Hall effect switching circuit 40 includes a first magnetic polarity detecting unit 410, a second magnetic polarity detecting unit 420 and a detecting and controlling unit 450. The first polarity detecting unit 410 is configured for detecting a magnetic field intensity of the magnetic south pole, and includes a Hall device 411, an amplifier 412, a comparator 413 and a switching unit 430. The first magnetic polarity detecting unit 410 is connected to the detecting and controlling unit 450 via the switching unit 430. The second magnetic polarity detecting unit 420 is configured for detecting a magnetic field intensity of the magnetic north pole, and includes a Hall device 421, an amplifier 422, a comparator 423 and a switching unit 440. The second magnetic polarity detecting unit 420 is connected to the detecting and controlling unit 450 via the switching unit 440. In fact, the detecting and controlling unit 450 is configured for controlling on/off operation of any one of the first magnetic polarity detecting unit 410 and the second magnetic polarity detecting unit 420 to produce a corresponding output signal. For example, the detecting and controlling unit 450 may control on/off states of the switching units 430 and 440 to selectably use an output signal sent out from the first magnetic polarity detecting unit 410 or the second magnetic polarity detecting unit 420. Alternatively, the detecting and controlling unit 450 may control the on/off operations of the Hall devices 411 and 421 to control the first magnetic polarity detecting unit 410 and the second magnetic polarity detecting unit 420 whether or not produce the corresponding output signals.

Similar to those as shown in FIG. 5, it should be obvious for persons skilled in the art that, the switching units 430 and 440 are not essential elements of this exemplary embodiment.

The detecting and controlling unit 450 includes a detect and setup time defined therein. When resetting a power supply, the Hall effect switching circuit 40 starts. In the detect and setup time, the detecting and controlling unit 450 can judge the polarity of the magnetic field according to the output signals sent out from the first magnetic polarity detecting unit 410 and the second magnetic polarity detecting unit 420. If the polarity of the magnetic filed is the magnetic south pole, the switching unit 440 connected to the second magnetic polarity detecting unit 420 will be turned off to select the output signal sent out from the first magnetic polarity detecting unit 410 as a switching signal in the detect and setup time. Therefore, an output signal sent out from the Hall effect switching circuit 40 is only related to the magnetic field intensity of the magnetic south pole, and a relation between the output signal thereof and the magnetic field intensity is shown in FIG. 2(a). If the polarity of the magnetic field is the magnetic north pole, the switching unit 430 connected to the first magnetic polarity detecting unit 410 will be turned off to select the output signal sent out from the second magnetic polarity detecting unit 420 as the switching signal in the detect and setup time. Thus the output signal sent out from the Hall effect switching circuit 40 is only related to the magnetic field intensity of the magnetic north pole, and the relation between the output signal thereof and the magnetic field intensity is shown in FIG. 2(b).

Compared with the conventional art, the detecting and controlling unit 450 of the Hall effect switching circuit 40 includes the two magnetic polarity detecting units to judge the magnetic field intensity of the magnetic south pole and the magnetic north pole respectively, thus an oriented direction thereof is not limited. Furthermore, the detecting and controlling unit 450 is configured for judging the polarity of the magnetic field in the detect and setup time to select one magnetic polarity detecting unit for judging the magnetic field intensity thereof, thus the misoperation phenomenon introduced by noise may be avoided.

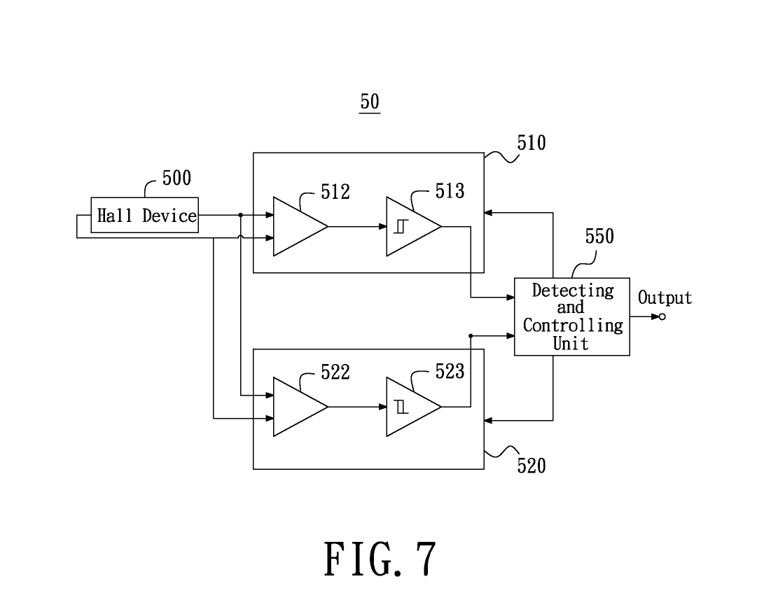

Referring to FIG. 7, a Hall effect switching circuit in accordance with a third exemplary embodiment of the present invention is provided. In this exemplary embodiment, the Hall effect switching circuit 50 includes a Hall device 500, a first magnetic polarity detecting unit 510, a second magnetic polarity detecting unit 520 and a detecting and controlling unit 550. The Hall device 500 is configured for sensing an signal in relation to a magnetic field. The first polarity detecting unit 510 is configured for detecting a magnetic field intensity of the magnetic south pole, and is connected to the detecting and controlling unit 550. The first magnetic polarity detecting unit 510 includes an amplifier 512 and a comparator 513. The second magnetic polarity detecting unit 520 is configured for detecting a magnetic field intensity of the magnetic north pole, and is connected to the detecting and controlling unit 550. The second magnetic polarity detecting unit 520 includes an amplifier 522 and a comparator 523. The detecting and controlling unit 550 is configured for controlling output signals sent out from the first magnetic polarity detecting unit 510 and the second magnetic polarity detecting unit 520 to selectably use the output signal sent out from the first magnetic polarity detecting unit 510 or the second magnetic polarity detecting unit 520. The first magnetic polarity detecting unit 510 and the second magnetic polarity detecting unit 520 may further include switching units to employ the detecting and controlling unit 550 to control the output signals thereof.

The detecting and controlling unit 550 includes a detect and setup time defined therein. When resetting a power supply, the Hall effect switching circuit 50 starts. In the detect and setup time, the detecting and controlling unit 550 can judge the polarity of the magnetic field according to the output signals sent out from the first magnetic polarity detecting unit 510 and the second magnetic polarity detecting unit 520. If the polarity of the magnetic filed is the magnetic south pole, the Hall effect switching circuit 50 will stop receiving the output signal sent out from the second magnetic polarity detecting unit 520 to select the output signal sent out from the first magnetic polarity detecting unit 510 as a switching signal in the detect and setup time. Therefore, an output signal sent out from the Hall effect switching circuit 50 is only related to the magnetic field intensity of the magnetic south pole, and a relation between the output signal thereof and the magnetic field intensity is shown in FIG. 2(a). If the polarity of the magnetic field is the magnetic north pole, the Hall effect switching circuit 50 will stop receiving the output signal sent out from the first magnetic polarity detecting unit 510 to select the output signal sent out from the second magnetic polarity detecting unit 520 as the switching signal in the detect and setup time. Thus the output signal sent out from the Hall effect switching circuit 50 is only related to the magnetic field intensity of the magnetic north pole, and the relation between the output signal thereof and the magnetic field intensity is shown in FIG. 2(b).

Compared with the conventional art, the detecting and controlling unit 550 of the Hall effect switching circuit 50 includes the two magnetic polarity detecting units to judge the magnetic field intensity of the magnetic south pole and the magnetic north pole respectively, thus an oriented direction thereof is not limited. Furthermore, the detecting and controlling unit 550 is configured for judging the polarity of the magnetic field in the detect and setup time to select one magnetic polarity detecting unit for judging the magnetic field intensity thereof, thus the misoperation phenomenon introduced by noise may be avoided.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A Hall effect switching circuit, comprising:
a magnetic south pole detecting unit configured for detecting and judging a magnetic field intensity of a magnetic south pole to produce a first triggering signal;
a magnetic north pole detecting unit configured for detecting and judging a magnetic field intensity of a magnetic north pole to produce a second triggering signal; and
a detecting and controlling unit connected to the magnetic south pole detecting unit and the magnetic north pole detecting unit, the detecting and controlling unit being configured for judging a polarity of a magnetic field according to the first triggering signal and the second triggering signal, and selecting a triggering signal corresponding to the polarity of the magnetic field as a switching signal of the Hall effect switching circuit in a predetermined detect and setup time after starting the Hall effect switching circuit.

2. The Hall effect switching circuit as claimed in claim 1, further comprising:
a first switching unit coupled between the magnetic south pole detecting unit and the detecting and controlling unit, the first switching unit being configured for employing the detecting and controlling unit to select the first triggering signal produced from the magnetic south pole detecting unit; and
a second switching unit coupled between the magnetic north pole detecting unit and the detecting and controlling unit, the second switching unit being configured for employing the detecting and controlling unit to select the second triggering signal produced from the magnetic north pole detecting unit.

3. The Hall effect switching circuit as claimed in claim 1, wherein the magnetic south pole detecting unit comprises:
a first Hall device configured for sensing the magnetic field intensity of the magnetic south pole to produce a sensing voltage;
a first amplifier configured for amplifying the sensing voltage; and
a first comparator configured for judging the magnetic field intensity of the magnetic south pole according to the amplified sensing voltage to produce the first triggering signal;
wherein the first Hall device, the first amplifier and the first comparator are connected in series.

4. The Hall effect switching circuit as claimed in claim 1, wherein the magnetic north pole detecting unit comprises:
a second Hall device configured for sensing the magnetic field intensity of the magnetic north pole to produce a sensing voltage;
a second amplifier configured for amplifying the sensing voltage; and
a second comparator configured for judging the magnetic field intensity of the magnetic north pole according to the amplified sensing voltage to produce the second triggering signal;
wherein the second Hall device, the second amplifier and the second comparator are connected in series.

5. A Hall effect switching circuit, comprising:
a Hall device configured for sensing an intensity of a magnetic field to produce a sensing voltage;
a magnetic south pole detecting unit configured for judging a magnetic field intensity of a magnetic south pole according to the sensing voltage to produce a first triggering signal;
a magnetic north pole detecting unit configured for judging a magnetic field intensity of a magnetic north pole according to the sensing voltage to produce a second triggering signal; and
a detecting and controlling unit connected to the magnetic south pole detecting unit and magnetic north pole detecting unit, the detecting and controlling unit being configured for judging a polarity of the magnetic according to the first triggering signal and the second triggering signal to select one triggering signal corresponding to the polarity of the magnetic field as a switching signal of the Hall effect switching circuit in a predetermined detect and setup time after starting the Hall effect switching circuit.

6. The Hall effect switching circuit as claimed in claim 5, wherein the magnetic south pole detecting unit comprises:
a first amplifier configured for amplifying the sensing voltage; and
a first comparator connected to the first amplifier and configured for judging the magnetic field intensity of the magnetic south pole according to the amplified sensing voltage to produce the first triggering signal.

7. The Hall effect switching circuit as claimed in claim 5, wherein the magnetic north pole detecting unit comprises:
a second amplifier configured for amplifying the sensing voltage; and
a second comparator connected to the first amplifier and configured for judging the magnetic field intensity of the magnetic north pole according to the amplified sensing voltage to produce the second triggering signal.

8. A Hall effect switching circuit, comprising:
a Hall device configured for sensing an intensity of a magnetic field to produce a sensing voltage;
a first comparator connected to the Hall device and configured for judging a magnetic field intensity of a magnetic south pole according to the sensing voltage to produce a first triggering signal;
a second comparator connected to the Hall device and configured for a magnetic field intensity of a magnetic north pole according to the sensing voltage to produce a second triggering signal; and
a detecting and controlling unit connected to the first comparator and the second comparator, the detecting and controlling unit being configured for judging a polarity of the magnetic according to the first triggering signal and the second triggering signal to select one triggering signal corresponding to the polarity of the magnetic field as a switching signal of the Hall effect switching circuit in a predetermined detect and setup time after starting the Hall effect switching circuit.

9. The Hall effect switching circuit as claimed in claim 8, further comprising:
an amplifier coupled between the Hall device and the first comparator and the second comparator, the amplifier being configured for amplifying the sensing voltage.

10. The Hall effect switching circuit as claimed in claim 8, further comprising:
a first switching unit coupled between the first comparator and the detecting and controlling unit, the first switching unit being configured for employing the detecting and controlling unit to select the first triggering signal produced from the first comparator; and
a second switching unit coupled between the second comparator and the detecting and controlling unit, the second switching unit being configured for employing the detecting and controlling unit to select the second triggering signal produced from the second comparator.

11. A controlling method for a Hall effect switching circuit, comprising:
judging a magnetic field intensity of a magnetic south pole to produce a first triggering signal;
judging a magnetic field intensity of a magnetic north pole to produce a second triggering signal;
judging a polarity of a magnetic field according to the first triggering signal and the second triggering signal in a predetermined detect and setup time; and
selecting one triggering signal corresponding to the polarity of the magnetic field as a switching signal of the Hall effect switching circuit.

12. The controlling method as claimed in claim 11, wherein the step of producing the first triggering signal comprises:
sensing the magnetic field intensity of the magnetic south pole to produce a sensing voltage;
amplifying the sensing voltage; and
judging the magnetic field intensity of the magnetic south pole according to the amplified sensing voltage to produce the first triggering signal.

13. The controlling method as claimed in claim 11, wherein the step of producing the second triggering signal comprises:
sensing the magnetic field intensity of the magnetic north pole to produce a sensing voltage;
amplifying the sensing voltage; and
judging the magnetic field intensity of the magnetic north pole according to the amplified sensing voltage to produce the second triggering signal.

14. A controlling method for a Hall effect switching circuit, comprising:
sensing an intensity of a magnetic field to produce a sensing voltage;
amplifying the sensing voltage;
judging a magnetic field intensity of a magnetic south pole according to the amplified sensing voltage to produce a first triggering signal;
judging a magnetic field intensity of a magnetic north pole according to the amplified sensing voltage to produce a second triggering signal;
judging a polarity of the magnetic field according to the first triggering signal and the second triggering signal; and
selecting one triggering signal corresponding to the polarity of the magnetic field as a switching signal of the Hall effect switching circuit.
